(19) United States
(12) Patent Application Publication
(10) Pub. No.: US 2011/0317302 A1
(43) Pub. Date: Dec. 29, 2011

(54) DISK STORAGE APPARATUS AND METHOD OF MEASURING FLYING HEIGHT OF A HEAD

(75) Inventors: Yuji SAKAI, Yokohama-shi (JP); Kazuhito SHIMOMURA, Fussa-shi (JP); Masahide KANEGAE, Tama-shi (JP)

(73) Assignee: KABUSHIKI KAISHA TOSHIBA, Tokyo (JP)

(21) Appl. No.: 13/048,297

(22) Filed: Mar. 15, 2011

(30) Foreign Application Priority Data
Jun. 24, 2010 (JP) 2010-144146

(51) Int. Cl. G11B 27/36

(52) U.S. Cl. 360/31; G9B/27.052

(57) ABSTRACT

According to one embodiment, a disk storage apparatus includes a read module, a measuring module, and a compensating module. The read module is configured to read first and second signals recorded on a disk, from which to measure the flying height of a head. The measuring module is configured to calculate the flying height of the head from the first and second measurement signals read by the read module. The compensating module is configured to use the data representing the flying height representing error resulting from superparamagnetic effect, thereby compensating for the flying height measured by the measuring module.

### CROSS-REFERENCE TO RELATED APPLICATIONS

This application is based upon and claims the benefit of priority from Japanese Patent Application No, 2010-144146, filed Jun. 24, 2010; the entire contents of which are incorporated herein by reference.

### FIELD

Embodiments described herein relate generally to a technique of measuring the flying height of a head incorporated in a disk storage apparatus.

### BACKGROUND

In most disk storage apparatuses (hereinafter referred to as “disk drives” in some cases), a representative example of which is the hard disk drive, a head reads or writes data from or to a disk used as a recording medium, while it is flying above the disk. The flying height of the head influences the data recording and reproducing characteristic of the disk drive, and should therefore be set to an optimal value.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram explaining the configuration of a disk drive according to an embodiment;

FIG. 2 is a diagram explaining flying height measuring errors made in the embodiment;

FIG. 3 is a diagram explaining how to record signals for measuring the flying height in the embodiment;

FIG. 4 is another diagram explaining how to record signals for measuring the flying height in the embodiment;

FIG. 5 is a diagram explaining how flying height measuring errors are determined in the embodiment;

FIG. 6 is a diagram explaining a ratio of one flaring height measuring error to another flying height measuring error, which is observed in the embodiment;

FIGS. 7A and 7B are diagrams explaining a process of correcting the flying height measured in the embodiment;

FIGS. 8A and 8E are diagram explaining another process of correcting the flying height measured in the embodiment; and

FIG. 9 is a flowchart explaining the sequence of a method of measuring the flying height in the embodiment.

### DETAILED DESCRIPTION

Various embodiments will be described hereinafter with reference to the accompanying drawings.

To accomplish achieving a high recording density, a technique of reducing the head flying height with respect to the disk has been developed in recent years. The dynamic flying height (DFH) control is broadly practiced as a technique of controlling the head flying height. The DFH control is a heat control to maintain the head flying height at a constant value. More specifically, a current is made to flow in the heater coil mounted on the head slider, thereby heating the distal end of the slider, on which the read/write element of the head is mounted. So heated, the distal end of the slider undergoes thermal expansion.

The head flying height is known to change as the ambient temperature changes and as the head moves in the radial direction of the disk. The higher the ambient temperature, the smaller the head flying height will be. Conversely, the lower the ambient temperature, the larger the head flying height will be. In most cases, if the head flying height is large, the error rate during the reproduction of data from the disk will be high.

In view of this, a technique has been recently proposed, in which the head flying height is measured at high precision all the time the disk drive is operating, and the DFH control maintains the head flaring height at a constant small value.

An effective method of measuring the head flying height at high precision is to record measurement signals on the disk and to calculate the head flying height from the measurement signals read by the head from the disk. During the magnetic recording, a phenomenon called either the superparamagnetic effect or thermal decay may occur. This phenomenon causes the magnetization of the recording layer of the disk to deteriorate with time, ultimately degrading the signals recorded in the recording layer. As a result, the measurement signals are also degraded with time, possibly making measuring errors in the method of measuring the head flying height.

In general, according to one embodiment, a disk storage apparatus includes a read module, a calculation module, and a compensating module. The read module is configured to read first and second signals recorded on a disk, from which to measure the flying height of a head. The calculation module is configured to calculate the flaring height of the head from the first and second measurement signals read by the read module. The compensating module is configured to compensate for the flying height calculated by the calculation module, which includes error resulting from the superparamagnetic effect.

The embodiment will be described with reference to the accompanying drawings.

[Configuration of the Disk Drive]

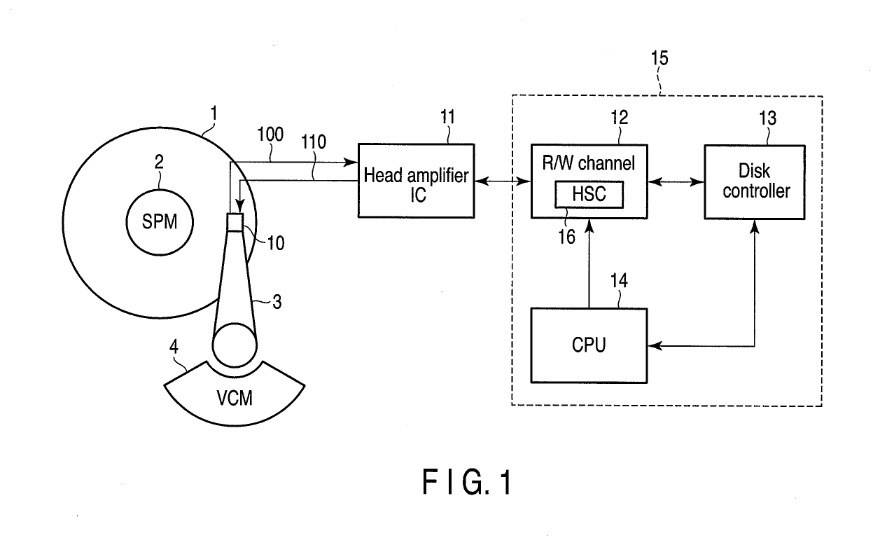

FIG. 1 is a block diagram showing the major components of a disk drive according to an embodiment.

As seen from FIG. 1, the disk drive is a drive of the perpendicular magnetic recording type. The disk drive comprises a head-disk assembly (HDA), a head amplifier integrated circuit (hereinafter referred to as a “head amplifier IC”) 11, and a hard disk controller (HDC) 15.

The HDA has a disk 1, a spindle motor (SPM) 2, an arm 3, and a voice coil motor (VCM) 4. The disk 1 is a recording medium for achieving perpendicular magnetic recording. The arm 3 holds a head 10. The spindle motor 2 rotates the disk 1. The arm 3 and the VCM 4 constitute an actuator. The VCM 4 drives the arm 3, whereby the head 10 is moved to a designated position above the disk 1.

The head 10 has a slider, a read head element and a write head element. The slider is the main unit of the head 10, and holds both the read head element and the write head element. The read head element reads data 100 from the disk 1. (The data 100 contains measurement signals, which will be described later.) The write head element writes data 110 to the disk 1. (The data 110 contains measurement signals, which will be described later.)

A heater coil (not shown), which is indispensable to DFH control, is mounted on the slider. In the DFH control, a current is made to flow in the heater coil, thereby heating the distal end of the slider, on which the write head element is mounted. So heated, the distal end of the slider expands, reducing the flying height. Conversely, the amount of heat applied to the distal end of the slider may be decreased, contracting the distal end of the slider. In this case, the flying height is increased. The head-disk assembly (HDA) includes a temperature sensor that starts detecting the temperature in the disk drive when the power switch of the disk drive is turned on.

The head amplifier IC 11 has a read amplifier and a write driver. The read amplifier amplifies any read signal the read head element has output, and then supplies the read signal to the read/write (R/W) channel 12 provided in the HDC 15. The write driver receives any write signal current 110 output from the R/W channel 12 and corresponding to write data, and supplies the write signal current 110 to the write head element. The head amplifier IC 11 includes a heating driver configured to make a current flow in the heater coil during the DFH control.

The HDC 15 includes a disk controller 13 and a microprocessor (CPU) 14, in addition to the R/W channel 12. The R/W channel 12 includes a read channel and a write channel. The read channel processes any signal representing read data. The write channel processes any signal representing write data. The R/W channel 12 further includes a harmonic sensing control (HSC) module 16. The HSC module 16 calculates a flying height of the head 3 from the flying height measurement signals (also called “measurement signals” in some cases) recorded on the disk, as will be explained later.

The disk controller 13 performs an interface control, controlling the data transfer between a host system (not shown) and the R/W channel 12. The disk controller 13 includes a DFH control module, which performs DFH control, controlling the current supplied to the heater coil through the head amplifier IC 11. The CPU 14 is the main controller of the disk drive, and performs the servo control to position the head 4 at a desired position over the disk 1 and the data read/write control. The CPU 14 also performs a process of correcting the flying height measured by the HSC module 16, and cooperates with the DFH control module to control the flying height of the head 10.

[Method of Measuring the Flying Height]

The principle of measuring the flying height of the head 10 will be explained first.

The relationship that flying height d has with the amplitude A of a signal the head 10 reproduces from a signal recorded at wavelength λ is given by the following equation (1), which is called Wallance's equation:

d=(−λ/2π)·log A+C (1)

where A=C exp(−2πd/λ), C is an indefinite constant that does not depend on the flying height d, and log is the natural logarithm.

Since the equation has constant C, flying height d cannot be directly obtained. Therefore, amplitude A₀ is measured while the head 10 remains contacting the disk 1. The relationship that relative flying height d₀ has with the amplitude A₀ is determined as: d₀=(−λ/2π) log A₀+C.

The absolute flying height d the head 10 has with respect to the disk 1 is obtained by the following equation (2), from the relationship between d and amplitude A defined in the equation (1) and the relationship between d₀ and amplitude A described above:

d−d₀=(−λ/2π)·(log A−log A₀) (2)

As seen from the equation (2), the indefinite constant C is cancelled. As a result, if d₀=0, the absolute flying height d can be obtained by the following equation (3):

d=(−λ/2π)·(log A−log A₀) (3)

In the disk drive, however, the gain of the read amplifier incorporated in the head amplifier IC 11 changes because of, for example, changes in temperature. That is the signal amplitude A changes due to a factor other than the flying height. To eliminate such a change in the signal amplitude A, thereby to make the disk drive more practical, the flying height d can be calculated by the following equation (4) having amplitude ratio A_{fa}/A_{fb} between two frequency components A_{fa} and A_{fb} of the same reproduced signal, obtained at two frequencies fa and fb, respectively:

d=K·log(A_{fa}/A_{fb})+C (4)

where A_{fa}/A_{fb}=[Ca exp(−2πd/λa)]/[Cb exp(−2πd/λb)], λa=v/fa and λb=v/fb at the circumferential speed v of the disk 1, K=1/[2π(1/λb−1/λa)]=v/[2π(fb−fa)], and Ca and Cb are indefinite constants that do not depend on the flying height d.

Amplitude components A_{0fa} and A_{0fa} are measured while the head 10 remains contacting the disk 1. The relationship that relative flying height d₀ has with the amplitude components A_{Ofa} and A_{0fa} is determined as: d₀=K log(A_{0fa}/A_{0fa})+C. On the other hand, the absolute flying height the disk 10 has with respect to the disk 1 is obtained by the following equation (5), from the relationship of the frequency components A_{fa} and A_{fb} and the relative flying height d₀:

d−d₀=d=K·[log(A_{fa}/A_{fb})−log(A_{0fa}/A_{0fb})] (5)

Here, the indefinite constant C is cancelled. Thus, C=0 in most cases. Hereinafter, C will be regarded as zero (C=0). The frequencies fa and fb used to measure the amplitude of the signal can be set to any values. However, a signal is usually used repeatedly, which has a specific frequency. The amplitude component A_{f1} of the fundamental wave f1 of the signal and the amplitude component of the third harmonic f3 of the signal are utilized. In order to extract these amplitude components at the frequencies f1 and f2, respectively, the signal is subjected to discrete Fourier transformation (DFT).

The principle of measuring the flying height of the head 10 has been explained. If the flying height is measured the disk drive in accordance with the principle, however, the following events will take place.

To cancel the indefinite constant C, thereby to find the absolute flying height d, it is necessary to obtain not only the amplitude components A_{fa} and A_{fb} at the flying height, but also the amplitude components A_{0fa} and A_{0fb} at time the head 10 remains contacting the disk 1. Any measurement reproduced from the disk 1 inevitably changes in amplitude. Therefore, the amplitude components A_{0fa} and A_{0fb} at time the head 10 must be measured again, while keeping the head 10 in contact with the disk 1.

If the head 10 frequently contacts the disk 1, either the head 10 or the disk 1 will be worn, possibly reducing the performance of the disk drive. This is why each measurement signal is recorded only once, not recorded again, in most cases. Nonetheless, the disk 1 is gradually demagnetized as time passes, because of the phenomenon known as the superparamagnetic effect or thermal decay, as pointed out above. After a long lapse of time from the recording of the flying height measurement signal, the signal changes due to the superparamagnetic effect, making a flying height measuring error.

To be more specific, the amplitude components A_{0fa} and A_{0fb} measured while the head 10 is contacting the disk 1 increases α times and β times, changing to αA_{fa} and βA_{fb}, respectively. The relative flying height dr measured in this condition is: dr=K log(αA_{fa}/βA_{fb})=K log(A_{fa}/A_{fb})+K log(α/β). That is, a flying height measuring error, K log(α/β), is made. The error K log(α/β) is a parameter that does not depend on the flying height measured. The error changes, depending on only the time passed after the recording, no matter how the flying height of the head 10 changes.

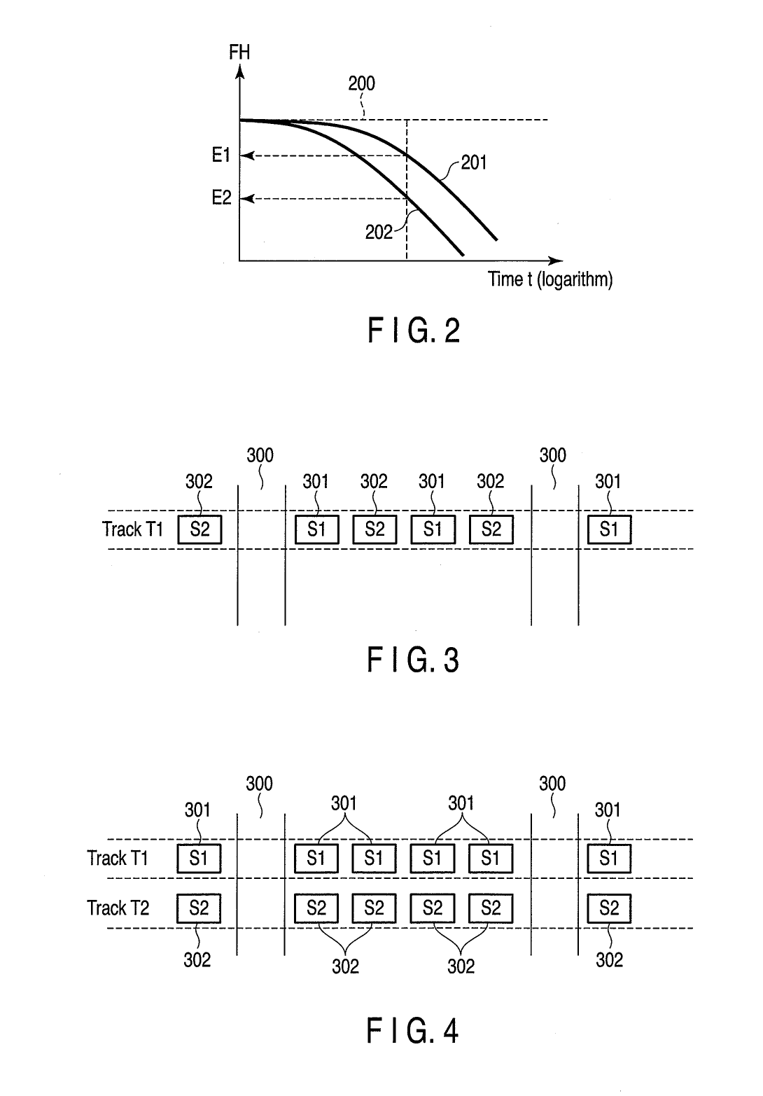

A method of measuring the flying height in this embodiment will be explained with reference to FIG. 2 to FIG. 9.

In the disk drive, the CPU 14 measures the flying height of the head 10 at regular time intervals. As shown in FIG. 9 first and second measurement signals S1 and S2 of different frequencies are recorded in a designated area provided on the disk 1 during the manufacture of the disk drive (Block 20).

More precisely, as shown in FIG. 3, measurement signal S1 and measurement signal S2 are alternately recorded, in units of sectors, in the sectors, in a designated track T1 provided on the disk 1. Alternatively, as shown in FIG. 4, a first recording area 301 and a second recording area 302 may be allocated to two adjacent tracks T1 and T2, respectively. In this case, measurement signal S1 is recorded, in units of sectors, in track T1, and measurement signal S2 is recorded, in units of sectors, in track T2.

After the disk drive has been shipped from the manufacturer, the CPU 10 causes the head 10 to read the measurement signals S1 and S2 from the disk 1. The measurement signals S1 and S2 thus read are supplied to the R/W channel 12. The HSC module 16 of the R/W channel 12 calculates the mean value of the flying heights of the head 10 from the measurement signals S1 and 32, in accordance with the measuring principle described above (Blocks 21 and 22). Assume that correct flying height FH(t) is measured at time t. Further assume that flying height FH1(t) and flying height FH2(t) are obtained from a measurement signal S1 and a measurement signal 32, respectively.

Then, the CPU 14 acquires measuring error data from a flash memory (Block 23). The measuring error data represents the flying height measuring errors E1 and E2 and the ratio G of error E2 to error E1 (G=E2/E1). Using the measuring error ratio G, the CPU 14 corrects the flying height calculated by the HSC module 16, calculating correct flying height FH(t) (Block 24).

This process of measuring the flying height will be described in detail, with reference to FIG. 2 to FIG. 7 and FIGS. 8A and 8B.

Assume that during the test of the disk drive manufactured, the disk drive is so operated that the head 10 has a flying height FH having value 200, after measurement signals S1 and 22 have been recorded on the disk. As described above, the flying height FH having value 200 gradually decreases with time (log time) because of the superparamagnetic effect.

The flying height 201 calculated from measurement signal S1 is therefore detected as a measuring error E1 at time (t) with respect to the value 200. Similarly, the flying height 202 calculated from measurement signal S2 is detected as a measuring error E2 at time (t) with respect to the value 200. The ratio G of error E2 to error E1 (G=E2/E1) is calculated and saved in the flash memory as measuring error data.

In this embodiment, the CPU 14 cancels the flying height measuring error from the flying height calculated by the HSC module 16, thereby calculating correct flying height FH(t). Thus, the CPU 14 can obtain correct flying height FH(t) by the following equation (6):

FH(t)=(G×FH1(t)−FH2(t))/(G−1) (6)

where G=E2/E1.

Correct flying height FH(t) corresponds to the flying height the head 10 has at time t after the ratio G has been obtained, as can be seen from FIG. 2.

The flaring height measuring errors E1 and E2 can be handled as independent events that do not depend on the flying height of the head 10 FH1(t) is the flying height obtained from measurement signal S1 at time t in a given flying state of the head 10. Hence, FH1(t) is the sum of the correct flying height FH(t) and the measuring error E1(t) resulting from the superparamagnetic effect, i.e., FH1(t)=FH(t)+E1(t). Similarly, FH2(t) is the flying height obtained from measurement signal S2 at time t in a given flying state of the head 10, and is the sum of the correct flying height FH(t) and the measuring error E2(t) resulting from the superparamagnetic effect, i.e., FH2(t)=FH(t)+E2(t). Since E2(t)/E1(t)=G at time t in a given flying state of the head 10, E1(t) and E2(t) cancel each other, the correct flying height FH(t) can be calculated, as seen from the equation (6).

In this embodiment, it is desired that the difference between the measuring errors E1 and E2 be as large as possible, if G is greater than 1 in the case where the measurement signals S1 and S2 recorded on the disk 1 are used to measure the flying height. As stated above, the measuring error E1 results from the superparamagnetic effect in the process of calculating the flying height from measurement signal S1. The measuring error E2 results from the superparamagnetic effect in the process of calculating the flying height from measurement signal S2. If G is less than 1, too, it is desired that the difference between the measuring errors E1 and 12 be as large as possible.

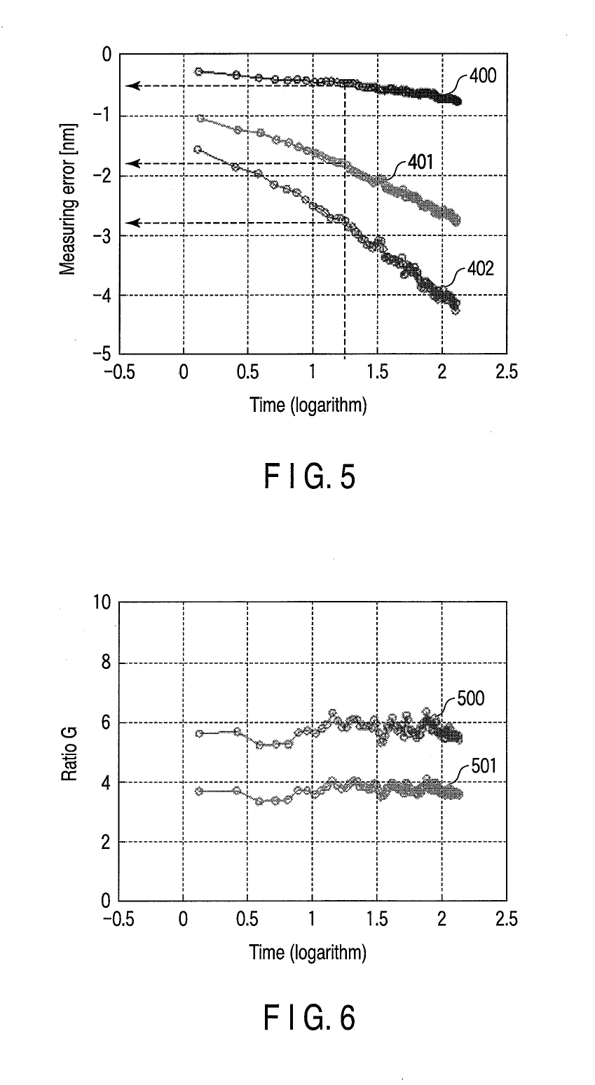

FIG. 5 shows a measuring error 400 made in measuring the flying height from a single-frequency signal of 7T-cycle, at the maximum recording frequency set to 1T cycle so that the flying height of the head 10 may become constant with respect to the disk 1. FIG. 5 also shows a measuring error 401 made in measuring the flying height from a single-frequency signal of 24T-cycle, lower frequency signal, also at the maximum recording frequency of 1T cycle. Further, FIG. 5 shows a measuring error 402 made in measuring the flying height from a single-frequency signal of 32T-cycle, still lower frequency signal, also at the maximum recording frequency of 1T cycle.

In FIG. 5, the time plotted on the horizontal axis is the time (Log time) passed from the recording of measurement signals. As seen from FIG. 5, the superparamagnetic effect becomes more prominent with time, gradually increasing the measuring errors 400 to 402. In the perpendicular magnetic recording, the smaller the flying height, the more prominent the flying height measuring error resulting from the superparamagnetic effect will be, if a single-frequency signal is used as flying height measurement signal.

As described above, the amplitude components A_{f1} of the fundamental wave of the single-frequency signal f1 and the amplitude components A_{f3} of the third harmonic wave f3 thereof are measured, thereby finding the relative flying height d, i.e., d=K log(A_{f1}/A_{f3}), where K=v/[2(f3−f1)]>0. The superparamagnetic effect is more prominent at the ±DC magnetization part than at the magnetization transition part. In any signal reproduced by the head 10, the superparamagnetic effect is observed as a concave at the ±DC magnetization part. This means that the amplitude component A_{f1} of the fundamental wave f1 decreases, while the amplitude component A_{f3} of the third harmonic wave f3 increases. Thus, the measured flying height gradually decreases.

In view of the mechanism of making flying height measuring errors because of the superparamagnetic effect, the shorter the ±DC magnetization part, or the higher the frequency of the signal, the smaller will be the flying height measuring error resulting from the superparamagnetic effect. As evident from FIG. 5, the lower the frequency of the measurement signal is, the larger the flying height measuring error over the same period of time. The superparamagnetic effect never ceases to exist. Therefore, it is difficult to eliminate the flying height measuring error even if high-frequency signals are used.

This is why a signal of 7T-cycle and a signal of 32T-cycle, for example, are used as measurement signals S1 and S2, respectively, in the present embodiment. As has been stated the ratio G (G=E2/E1) of the measuring error E2 to the measuring error E1, both resulting from the superparamagnetic effect is obtained while the flying height of the head 10 remains constant, after the measurement signals S1 and S2 have been recorded during the manufacture of the disk drive. In this case, G=E2/F1>1. However, G may be greater than 1 (G>1), as will be described below.

FIG. 6 is a diagram explaining a ratio G observed in experiments. In FIG. 5, characteristic 500 indicates how the ratio G changes with time when a signal of 7T-cycle and a signal of 24T-cycle are used as measurement signals S1 and S2, respectively. Characteristic 501 indicates how the ratio G changes with time when a signal of 7T-cycle and a signal of 32T-cycle are used as measurement signals S1 and S2, respectively. As seen from Characteristics 500 and 501 shown in FIG. 6, the ratio G approaches a certain value as the measuring errors E1 and E2 increases in absolute value after the measurement signals have been recorded on the disk 1.

A process of correcting the flying height will be explained, which is performed if the measured flying heights FH1(t) and FH2(t) obtained from the measurement signals S1 and S2, respectively, have errors resulting from any other factors than the superparamagnetic effect.

Assume that the flying heights FH1(t) and FH2(t) have errors α(t) and β(t) resulting from any other factors than the superparamagnetic effect. Then, the measured flying height FH1(t) is FH(t)+E1(t)+α(t), and the measured flying height FH2(t) is FH(t)+E2(t)+β(t). The corrected flying height HFa(t) can be expressed by the following equation (7):

FHa(t)=FH(t)+(G+α(t)−β(t))/(G−1) (7)

where FH(t) is the measured flying height not corrected yet, and G is the above-mentioned ratio E2/E1.

As can be understood from the equation (7), in a limited condition, FHa(t) infinitely increases (∞) as the ratio G approaches 1, and becomes α(t) as the ratio G increases infinitely. The larger the ratio G, the smaller the corrected errors will be. Hence, it is desired that the measurement signals S1 and S2 should be used in combination so that the difference between the measuring errors E1 and E2 resulting from the superparamagnetic effect may be as large as possible. Of the 7T-cycle signal 400, 24T-cycle signal 401 and 32T-cycle signal 402 shown in FIG. 5, the 7T-cycle signal 400 and the 32T-cycle signal 402 should best be used in combination (resulting in the characteristic 501 shown in 6). If the 7T-cycle signal is used in combination with a signal having a lower frequency than the 32-cycle signal, a larger ratio G will be obtained.

The relative flying height FH1 and FH2 measured from the measurement signals S1 and S2 may not change in accordance with the changes of the actual flaring height of the head 10. In this case, the measured relative flying height FH1 is K1 log(Af11/Af31), where K1=v/[2π(f31−f11)], and the measured relative flying height FH2 is K2 log(Af12/Af32), where K2=v/[2π(f32−f12)]. Here, K1 and K2 are coefficients, f11 is frequency 1/T, f31 is frequency 3/7T, f12 is frequency 1/24T, and f32 is frequency 3/24T. Further, T is a cycle, and Af is amplitude component of frequency f.

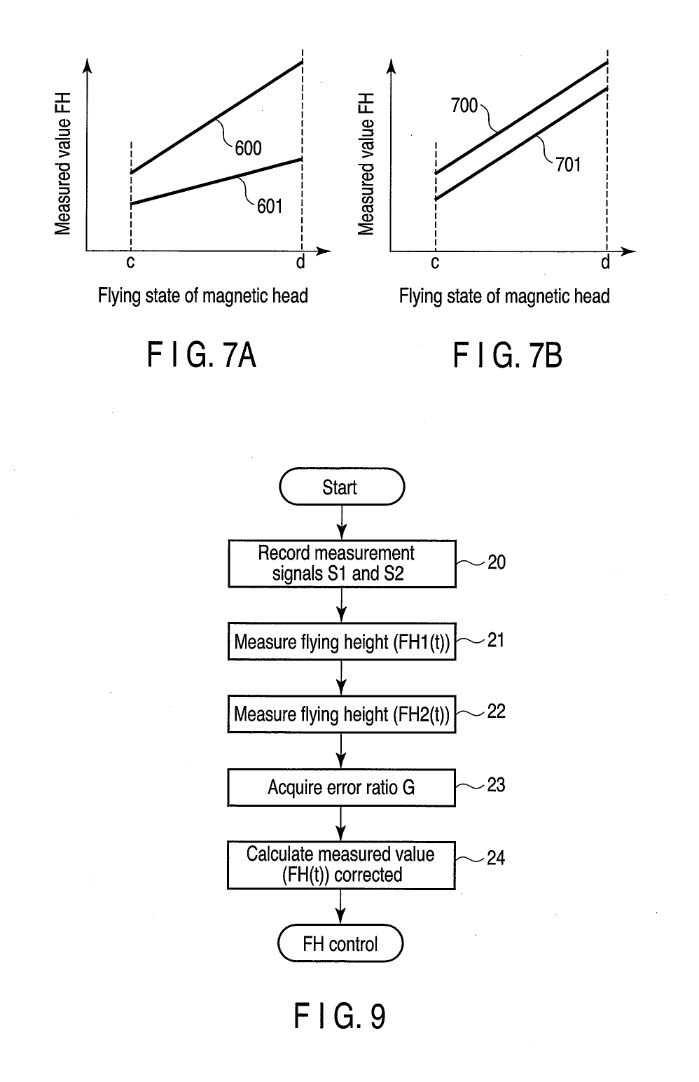

In this instance, the measured flying height differs from the absolute flying height measured while the head 10 remains contacting the disk 1. FIG. 7A shows the characteristics measured values 600 and 601, not corrected yet with coefficients K1 and K2, with respect to two different flying states c and d of the head 10, respectively, immediately after the measurement signals S1 and S2 have been recorded on the disk 1 (or when no superparamagnetic effect exists). The measured value 600 is value FH1 obtained from measurement signal S1, and the measured value 601 is value FH2 obtained from measurement signal S2.

Then, the coefficient K1 or the coefficient K2, or both are corrected, equalizing the changed FH1c of the measured value 600 obtained from measurement signal S1 to the changed FH2c of the measured value 601 obtained from measurement signal S2. FIG. 7B shows the characteristics of the measured values 700 (FH1) and 701 (FH2) which have been corrected with coefficients K1 and K2, respectively.

Here, the change FH1c of the measured flying height value FH1 is K1 [log(Af11c/Af31c)−log(Af11d/Af21d)]. The change FH2c of the measured value FH2 is K2 [log(Af12c/Af32c)−log(Af12d/Af32d)].

In order to correct the coefficients K1 and K2, the absolute flying height may be measured while the head 10 is flying. Then the coefficients K1 and K2 may be corrected to accord with the absolute flying height thus measured.

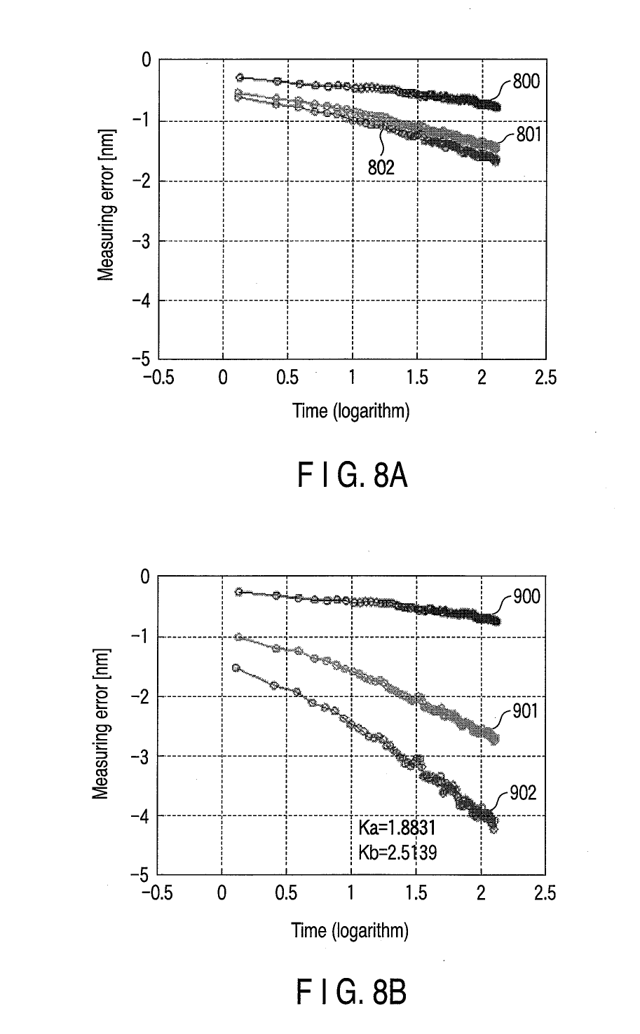

FIG. 8A shows the characteristics that the measuring errors 800 to 802 exhibit with respect to different flying states c and d of the head 10 before the coefficients Ka and Kb are corrected, if the absolute flying height obtained from the 7T-cycle signal used as a measurement signal. The measuring errors 800 to 802 are errors made as the superparamagnetic effect influences the flying heights obtained from 7T-cycle signal, 24T-cycle signal and 32T-cycle signal used as measurement signals.

The changes in the flying heights measured in given different flying states of the head 10 are used, obtaining a correction coefficient Ka for the 24T-cycle signal, and a correction coefficient Kb for the 32T-cycle signal. FIG. 8B shows the characteristics that the measuring errors 900 to 902 exhibit after the coefficients Ka and Kb have been corrected. The measuring errors 900 to 902 are errors made as the superparamagnetic effect influences the flying heights obtained from 7T-cycle signal, 24T-cycle signal and 32T-cycle signal used as measurement signals.

The flying height value FH1 measured from the 7T-cycle signal used as measurement signal is K1 log(Af11/Af31), where K1=v/[2π(f31−f11)]. The flying height value FH2 measured from the 24T-cycle signal used as measurement signal is Ka K2 log(Af12/Af32), where K2=v/[2π(f32−f12)]. Further, the flying height FH3 measured from the 32T-cycle signal used as measurement signal is Kb K3 log(Af13/Af33), where K3=v/[2π(f33−f13)]. Here, f11=frequency 1/7T, f31=frequency 3/7T, f12=frequency 1/24T, f32=frequency 3/24T, f13=frequency 1/32T, and f33=frequency 3/32T. T is cycle, and Af is an amplitude component of frequency f.

As has been described, the flying height the head 10 can be measured at high precision at all times in this embodiment, without frequently bringing the head 10 into contact with the disk 1. Therefore, neither the head 10 nor the disk 1 will be worn, preventing a decrease in the performance of the disk drive. Moreover, any flying height measured is corrected, achieving nigh-precision measuring of the head flying height at all times even if the flying height measured has an error resulting from the degradation the measurement signals recorded on the disk undergo with time because of the superparamagnetic effect, or thermal decay. The embodiment can thus prevent the measuring errors from increasing with time, and can measure the flying height of the head at high precision at all times.

Hence, in the disk drive according to this embodiment, the DFH control module incorporated in the disk controller 13 can reliably control the flying height of the head 10 to a small value, in accordance with the flying height measured at high precision.

The various modules of the systems described herein can be implemented as software applications, hardware and/or software modules, or components on one or more computers, such as servers. While the various modules are illustrated separately, they may share some or all of the same underlying logic or code. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A disk storage apparatus comprising:
a read module configured to read a first flying height measurement signal and a second flying height measurement signal recorded on a disk and have different frequencies;
a calculation module configured to calculate a flying height of a head based on the first and second flying height measurement signals; and
a compensating module configured to compensate the flying height calculated by the calculation module, using measurement error data of a flying height attributable to a superparamagnetic effect.

2. The disk storage apparatus of claim 1, further comprising a error calculation module configured to calculate a ratio between the first and second flying height measurement signals of different frequencies as the measurement error data, and to store the measurement error data in a storage device,
wherein the compensating module is further configured to read the measurement error data from the storage device and to correct the flying height.

3. The disk storage apparatus of claim 2, wherein the calculation module further comprises:
a reproduction module configured to use the head to reproduce the first flying height measurement signal recorded in a first recording area of the disk and the second flying height measurement signal recorded in a second recording area of the disk;
a module configured to calculate measurement error values included in flying height measurement values obtained from the first and second the first and second flying height measurement signals in a state where the head is kept at a predetermined flying height above the disk; and
a module configured to calculate the ratio between the measurement error values as the measurement error data.

4. The disk storage apparatus of claim 3, wherein the calculation module is further configured to calculate a flying height value FH1 based on the first flying height measurement signal S1 and including the measuring error value E1, and a flying height value FH2 based on the second flying height measurement signal S2 and including the measuring error E2, and wherein
the compensating module is further configured to perform correction using the ratio G between the measurement error values E1 and E2 (G=E2/E1), which are the measurement error data, and to calculate a corrected flying height value FH based on the formula FH=(G×FH1−FH2)/(G−1).

5. The disk storage apparatus of claim 1, wherein the first and second flying height measurement signals are used signals of different frequencies, determined based on a difference caused between obtained from the first and second fling height measurement values due to the superparamagnetic effect.

6. The disk storage apparatus of claim 5, wherein the first and second flying height measurement signals are determined as signals of different frequencies in such a manner as to increase the difference between the measurement error values, wherein when the ratio between the measurement error values is increased further when the ratio is not less than 1, and is decreased further when the ratio is not more than 1.

7. The disk storage apparatus of claim 5, wherein the calculation module comprises:
a module configured to extract, from the first flying height measurement signal, a first signal amplitude at a first frequency and a second signal amplitude at a second frequency; and
a module configured to extract, from the second flying height measurement signal, a third signal amplitude at a third frequency and a fourth signal amplitude at a fourth frequency.

8. The disk storage apparatus of claim 1, wherein the compensating module comprises:
a module configured to correct coefficients included in an amount of change of the flying height values measured from the first and second flying height measurement signals, in a given flying state of the head, when a measurement error other than that caused by the superparamagnetic effect is included, and to compensate the flying height calculated by the calculation module.

9. The disk storage apparatus of claim 8, wherein the first and second flying height measurement signals are recorded in different sectors of one track of the disk or in different tracks of the disk.

10. A method of determining a head flying height, for use in a disk storage apparatus including a disk and a head, the method comprising:
reading a first flying height measurement signal and a second flying height measurement signal recorded on a disk and having different frequencies;
calculating a flying height of the head based on the first and second flying height measurement signals; and
compensating for an error in the flying height calculation associated with measuring error data resulting from a superparamagnetic effect.
